(19) United States
(12) Patent Application Publication
(10) Pub. No.: US 2010/0171711 A1
(43) Pub. Date: Jul. 8, 2010

(54) PORTABLE ELECTRONIC DEVICE WITH TOUCH-SENSITIVE DISPLAY AND METHOD OF CONTROLLING SAME

(75) Inventors: David James MAK-FAN, Waterloo (CA); James Alexander ROBINSON, Waterloo (CA); Jason Tyler GRIFFIN, Waterloo (CA); Ken WU, Waterloo (CA); Robert James Lowles, (US)

Correspondence Address: Borden Ladner Gervais LLP, 1200 Waterfront Centre, 200 Burrad Street, P.O. Box 48600, Vancouver, BC, V7X 1T2, CA

(73) Assignee: RESEARCH IN MOTION LIMITED, Waterloo (CA)

(21) Appl. No.: 12/562,673

(22) Filed: Sep. 18, 2009

Related U.S. Application Data
(60) Provisional application No. 61/118,534, filed on Nov. 28, 2008.

(51) Int. Cl. G06F 3/041

(52) U.S. Cl. 345/173

(57) ABSTRACT

A method of controlling a portable electronic device having a touch-sensitive display includes detecting a first touch on the touch-sensitive display, detecting a second touch on the touch-sensitive display while the first touch is maintained, selecting one of the first and second touches as a selected touch based on start or end times of the first and second touches, and determining which one of a plurality of features is associated with a location of the selected touch.

### CROSS-REFERENCE TO RELATED APPLICATIONS

The present application claims the benefit of priority of U.S. Provisional Patent Application No. 61/118,534, filed Nov. 27, 2008, which is incorporated herein by reference.

### FIELD OF TECHNOLOGY

The present disclosure relates to portable electronic devices including touch-sensitive displays and the entry of features by user touch at the touch-sensitive display.

### BACKGROUND

Electronic devices, including portable electronic devices, have gained widespread use and may provide a variety of functions including, for example, telephonic, electronic messaging and other personal information manager (PIM) application functions. Portable electronic devices may include several types of devices including mobile stations such as simple cellular telephones, smart telephones, wireless PDAs, and laptop computers with wireless 802.11 or Bluetooth capabilities.

Portable electronic devices such as PDAs or smart telephones are generally intended for handheld use and ease of portability. Smaller devices are generally desirable for portability. A touch-sensitive display, also known as a touchscreen display, is particularly useful on handheld devices, which are small and have limited space for user input and output. The information displayed on the touch-sensitive displays may be modified depending on the functions and operations being performed. With continued demand for decreased size of portable electronic devices, touch-sensitive displays continue to decrease in size.

Improvements in portable electronic devices having touch-sensitive displays are therefore desirable.

### BRIEF DESCRIPTION OF THE DRAWINGS

FIG. 1 is a simplified block diagram of components including internal components of a portable electronic device according an aspect of an embodiment in accordance with the disclosure.

FIG. 2 is a front view of an example of a portable electronic device in accordance with the disclosure.

FIG. 3 is a cross-sectional side view through the line 210 of the portable electronic device of FIG. 2; in accordance with the disclosure.

FIG. 4 is a flowchart illustrating a method of controlling the portable electronic device according to an aspect of an embodiment in accordance with the disclosure.

FIG. 5 is a flowchart illustrating an example of a method of controlling the portable electronic device in accordance with the disclosure.

FIG. 6 to FIG. 8 are front views of the example of the portable electronic device operated in accordance with the disclosure.

FIG. 9 is a flow chart illustrating another example of a method of controlling the portable electronic device in accordance with the disclosure.

FIG. 10 to FIG. 15 are front views of the example of the portable electronic device operated in accordance with the disclosure.

### DETAILED DESCRIPTION

For simplicity and clarity of illustration, reference numerals may be repeated among the figures to indicate corresponding or analogous elements. In addition, numerous specific details are set forth in order to provide a thorough understanding of the embodiments described herein. The embodiments described herein may be practiced without these specific details. In other instances, well-known methods, procedures and components have not been described in detail so as not to obscure the embodiments described herein. Also, the description is not to be considered as limited to the scope of the embodiments described herein.

The disclosure generally relates to an electronic device, which in the embodiments described herein is a portable electronic device. Examples of portable electronic devices include mobile, or handheld, wireless communication devices such as pagers, cellular phones, cellular smart-phones, wireless organizers, personal digital assistants, wirelessly enabled notebook computers, and the like. The portable electronic device may also be a portable electronic device without wireless communication capabilities such as a handheld electronic game device, digital photograph album, digital camera, or other device.

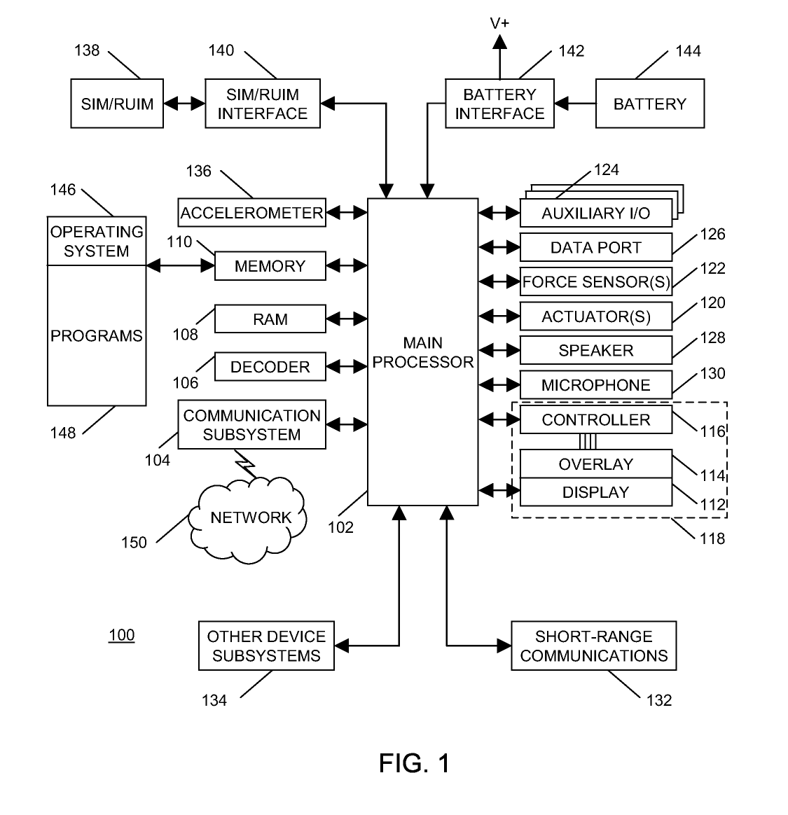

A block diagram of an example of an embodiment of a portable electronic device 100 is shown in FIG. 1. The portable electronic device 100 includes a number of components such as a processor 102 that controls the overall operation of the portable electronic device 100. Communication functions, including data and voice communications, are performed through a communication subsystem 104. Data received by the portable electronic device 100 is decompressed and decrypted by a decoder 106. The communication subsystem 104 receives messages from and sends messages to a wireless network 150. The wireless network 150 may be any type of wireless network, including, but not limited to, data-centric wireless networks, voice-centric wireless networks, and dual-mode networks that support both voice and data communications over the same physical base stations. The portable electronic device 100 is a battery-powered device and includes a battery interface 142 for receiving one or more rechargeable batteries 144.

The processor 102 also interacts with additional subsystems such as a Random Access Memory (RAM) 108, a memory 110, a display 112 with a touch-sensitive overlay 114 connected to an electronic controller 116 that together comprise a touch-sensitive display 118 (also referred to in the art as a touch screen display), an actuator 120, a force sensor 122, an auxiliary input/output (I/O) subsystem 124, a data port 126, a speaker 128, a microphone 130, short-range communications 132 and other device subsystems 134. The processor 102 interacts with the touch-sensitive overlay 114 via the electronic controller 116. Information, such as text, characters, symbols, images, and other items that may be displayed on a portable electronic device, is displayed on the touch-sensitive display 118 via the processor 102. The processor 102 may also interact with an accelerometer 136 as shown in FIG. 1. The accelerometer 136 may include a cantilever beam with a proof mass and suitable deflection sensing circuitry. The accelerometer 136 may be utilized for detecting direction of gravitational forces or gravity-induced reaction forces.

To identify a subscriber for network access according to the present embodiment, the portable electronic device 100 uses a Subscriber Identity Module or a Removable User Identity Module (SIM/RUIM) card 138 inserted into a SIM/RUIM interface 140 for communication with a network such as the wireless network 150. Alternatively, user identification information may be programmed into the memory 110.

The portable electronic device 100 also includes an operating system 146 and software components 148 that are executed by the processor 102 and are typically stored in a persistent store such as the memory 110. Additional applications may be loaded onto the portable electronic device 100 through the wireless network 150, the auxiliary I/O subsystem 124, the data port 126, the short-range communications subsystem 132, or any other suitable device subsystem 134.

In use, a received signal such as a text message, an e-mail message, or web page download is processed by the communication subsystem 104 and input to the processor 102. The processor 102 processes the received signal for output to the display 112 or alternatively to the auxiliary I/O subsystem 124. A subscriber may also compose data items, such as e-mail messages, for example, which may be transmitted over the wireless network 150 through the communication subsystem 104. For voice communications, the overall operation of the portable electronic device 100 is substantially similar except that the received signals are output to the speaker 128 and signals for transmission are generated by the microphone 130.

Graphical user interfaces including keyboards, for example, may be rendered on such touch-sensitive displays for user interaction. Such keyboards may include full keyboards with keys sized to fit the touch-sensitive device or may include reduced keyboards. Selection of features such as characters from a keyboard may be carried out using two thumbs, for example. When thumb typing, there may be overlap during which both thumbs are simultaneously touching the touch-sensitive display for selection of characters.

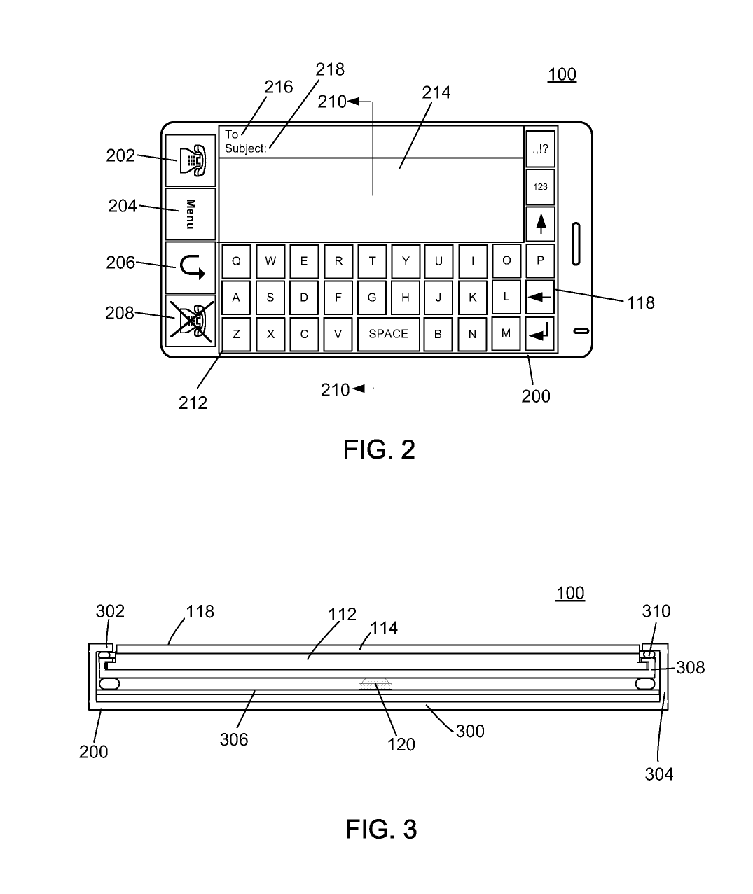

A front view of a portable electronic device 100 is shown in FIG. 2. The portable electronic device 100 includes a housing 200 that houses internal components, including internal components shown in FIG. 1, and frames the touch-sensitive display 118 such that an outer surface of the touch-sensitive display 118 is uncovered for user-interaction with the portable electronic device 100. The housing 200 may be comprised of one or more components and is suitable for housing the internal components shown in FIG. 1. As shown in FIG. 3, the housing 200 in the present example includes a back 300, a frame 302, which frames the touch-sensitive display 118, and sidewalls 304 that extend between and generally perpendicular to the back 300 and the frame 302. A base 306 is spaced from and is generally parallel to the back 300. The base 306 may be any suitable base such as a printed circuit board or flex circuit board supported by a stiff support between the base 306 and the back 300. The back 300 advantageously includes a plate (not shown) that is releasably attached for insertion and removal of, for example, the battery 144 and the SIM/RUIM card 138. The back 300, the sidewalls 304 and the frame 302 may be injection molded, for example, and may be separate pieces or one or more integrated pieces. In the example of the portable electronic device 100 shown in the figures, the frame 302 is generally rectangular with rounded corners, although other shapes are possible.

The display 112 and the touch-sensitive overlay 114 are supported on a support tray 308 of suitable material, such as magnesium, for providing mechanical support to the display 112 and the touch-sensitive overlay 114. A compliant gasket 310 is located around the perimeter of the frame 302, between an upper portion of the support tray 308 and the frame 302 to protect the components housed in the housing 200 from moisture, shock absorption, vibration damping and fatigue. A suitable material for the compliant gasket 310 includes, for example, a cellular urethane foam for providing shock absorption, vibration damping, and suitable fatigue life. The touch-sensitive display 118 is biased away from the base 306 and is moveable within the housing 200. The touch-sensitive display 118 may be moved away from the base 306, thereby compressing the compliant gasket 310. Further, the touch-sensitive display 118 may be moved toward the base 306, thereby applying a force to the actuator 120 referred to below. When force is applied, the touch-sensitive display 118 is depressible, pivotable, and/or movable. FIG. 3 is not drawn to scale for the purpose of clarity of illustration.

The actuator 120 is supported on one side of the base 306, between the base 306 and the support tray 308. The actuator 120, may be a mechanical dome-type switch, for example, and is located in a suitable position such that displacement of the touch-sensitive display 118 resulting from a pressing the touch-sensitive display 118 with sufficient force to overcome the bias and to overcome the actuation force for the actuator 120 depresses and actuates the actuator 120. In the present embodiment the actuator 120 is in contact with the support tray 308 and provides tactile feedback to the user when sufficient force is applied to the touch-sensitive display 118. In the example of a mechanical dome-type switch, application of sufficient force to the touch-sensitive display 118 causes collapse of the switch and the switch is released to return to the rest position when the force is removed, thereby providing the tactile feedback.

The actuator 120 may be used for further input to the processor 102 when actuated. Although a single switch is shown in FIG. 2, any suitable number of switches may be used. Further, the actuator 120 is not limited to a mechanical switch and may be, for example, a piezoelectric actuator cooperating with the force-sensor 122 for providing tactile feedback by controlling the charge at the piezoelectric actuator in response to detection of a threshold applied force on the touch-sensitive display 118.

The touch-sensitive overlay 114 is a capacitive touch-sensitive overlay. The touch-sensitive overlay 114 is an assembly of a number of layers in a stack and is fixed to the display using a suitable adhesive. The touch-sensitive overlay 114 include, for example, a substrate fixed to the LCD display 112 by a suitable adhesive, a ground shield layer, a barrier layer, a pair of capacitive touch sensors separated by a substrate or other barrier layer, and a cover layer fixed to a second capacitive touch sensor by a suitable adhesive. The capacitive touch sensors may be any suitable material such as indium tin oxide (ITO).

Both the x and y (e.g., horizontal and vertical with respect to a user's view of the display 118) location of a touch event on the touch-sensitive display may be determined. The x location may be determined by a signal generated as a result of capacitive coupling with one of the touch sensors, and the y location may be determined by a signal generated as a result of capacitive coupling with the other of the touch sensors. Each of the touch-sensors provides a signal to the controller 116 as a result of capacitive coupling with a suitable object, such as a finger of a user or a conductive stylus, resulting in a change in the electric field of each of the touch sensors. The signals represent the respective x and y touch location values. Other attributes of the touch on the touch-sensitive display 118 may also be determined. For example, the size and the shape of the touch on the touch-sensitive display 118 may be determined in addition to the location (x and y coordinate values) based on the signals received at the controller 116 from the touch sensors. Further, more than one touch location may be determined at any one time. Thus, simultaneous touches may be distinguished and the coordinates of each touch on the touch-sensitive display 118 may be determined.

A touch on the touch-sensitive display 118 is established by determining the x and y touch location and selected input is determined based on the x and y touch location and the application executed by the processor 102. Thus, a feature such as a virtual button displayed on the touch-sensitive display 118 may be selected by matching the feature to the x and y location of a touch event on the touch-sensitive display 118. Thus, a selected feature is determined based on the x and y touch location and the application.

The portable electronic device 100 may also include physical buttons. In the present example, the portable electronic device 100 includes four physical buttons 202, 204, 206, 208 in the housing 200 for selection for performing functions or operations. Buttons for performing functions on the portable electronic device 100 may also be virtual features rendered on the touch-sensitive display 118.

In the example shown in FIG. 2, a landscape mode virtual keyboard 212 is displayed on the touch-sensitive display 118 for entry of data in the form of, for example, text during operation of the portable electronic device 100. The virtual keyboard may be used for data entry in any suitable application such as in an electronic mail application, an Internet browser application, in an address book application or in any other suitable application. The landscape mode virtual keyboard 212 of FIG. 2 is provided for data entry for electronic mail composition and is shown as a full QWERTY keyboard for the purpose of the present example. The present disclosure is not limited to the landscape mode virtual keyboard 212 shown as other keyboards including reduced keyboards or other full keyboards are possible. The electronic mail composition screen shown in FIG. 2 includes a data entry field 214 as well as other fields such as a “To” field 216 for entry of an electronic mail address for a recipient and a “Subject” field 218 for entry of a subject of the electronic mail.

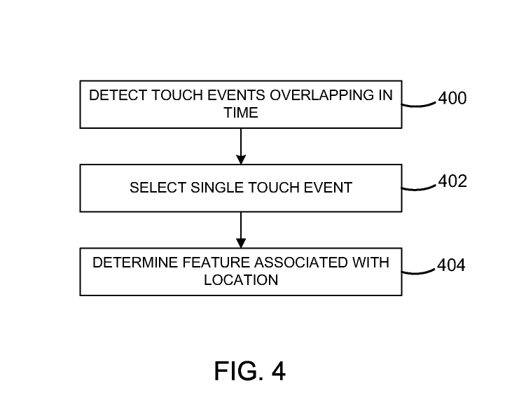

FIG. 4 shows a flowchart illustrating a method of controlling the portable electronic device 100. The flowchart of FIG. 4 may be carried out by software executed by the processor 102. Coding of software for carrying out such a method is within the scope of a person of ordinary skill in the art given the present description.

Two touches on the touch-sensitive display 118 that overlap in time are detected 400 and the x and y coordinates of each of the touches are determined. One of the two touches is selected 402 by disregarding signals from the touch-sensitive display 118 caused by the touch that is not selected. The coordinates of the selected touch are utilized to determine 404 which of a plurality of features is associated with the selected touch.

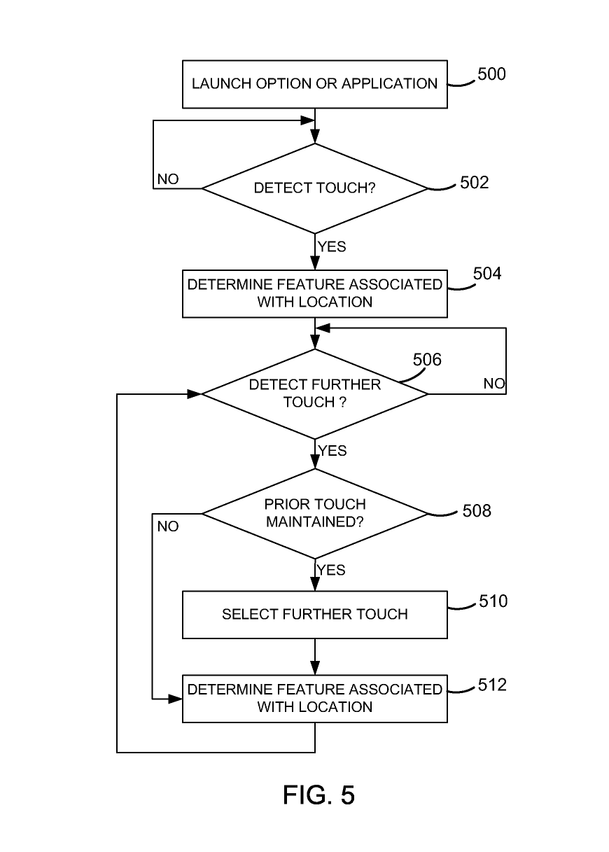

FIG. 5 is a flowchart illustrating an example of a method of controlling the portable electronic device 100 in accordance with FIG. 4. The processor 102 receives a selection of an application or an option within an application in which a graphical user interface is rendered and the selected option or application is launched 500. When a touch is detected 502, the coordinates of the touch are determined and the process continues at 504. If a touch is not detected, the process continues at 502. The portable electronic device 100 may repeatedly or continually monitor for a touch on the touch-sensitive display 118. The coordinates of the first touch are utilized to determine 504 which of a plurality of features is associated with the selected touch. When a further touch, i.e., a second touch, on the touch-sensitive display 118 is detected 506, the coordinates of the second touch are determined, and the process continues at 508. When the first touch is maintained when the second touch is detected, the process continues at 510. When two touches that overlap at least partially in time are detected, the x and y coordinates of each of the touches are determined. The second touch is selected 510 by disregarding signals from the touch-sensitive display 118 that are caused by the first touch and the coordinates of the second touch are utilized to determine 512 which of a plurality of features is associated with the selected touch. If the first touch is not maintained when the second touch is detected, the process continues at 512.

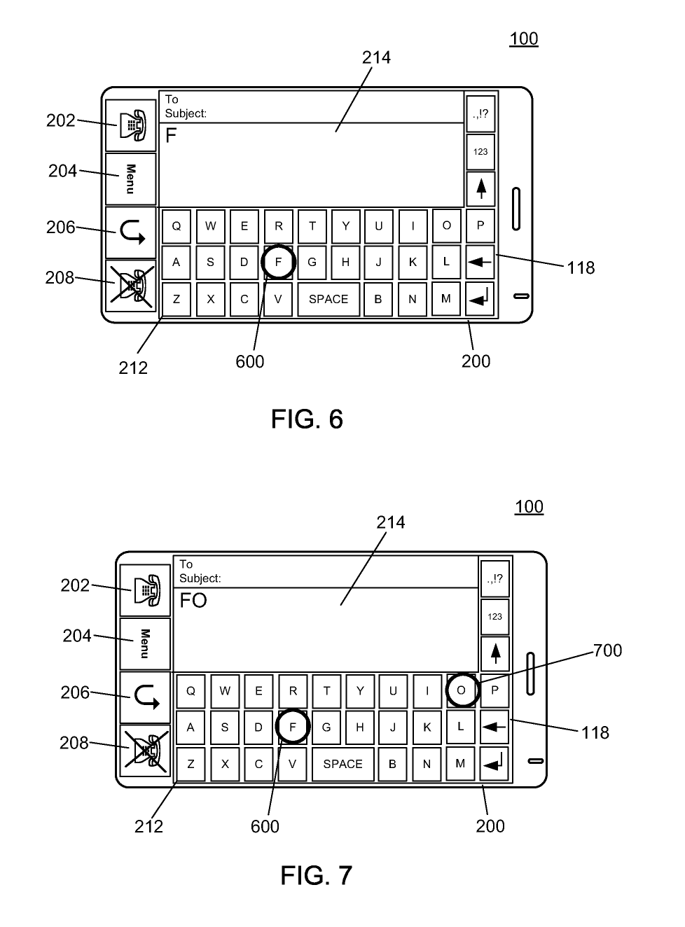

Continued reference is made to FIG. 5 with additional reference to FIG. 6 to FIG. 11 to describe a specific example of the method of controlling a portable electronic device 100.

According to the present example, the processor 102 receives a selection of an electronic mail composition option in an electronic mail application and an electronic mail composition application is launched 500. The virtual keyboard 212 is rendered in the electronic mail composition screen for entry of data in the form of characters such as alphanumeric characters and symbols in the fields 214, 216, 218.

In the present example, a touch is detected on the touch-sensitive display 118 at the location 600 shown in FIG. 6. Although an area is shown as the touch location 600, the touch area may be resolved into a single point when the touch location is determined. When a touch, or contact with the touch-sensitive display 118, is detected 502, the coordinates of the touch are determined. The coordinates of the touch are determined 504 to be associated with the virtual button for the letter “F” on the virtual keyboard 212 and the letter “F” is rendered in the data entry field 214 in which characters are entered. When a second touch, e.g., at a second location 602 in FIG. 7, is detected 506, the coordinates of the second touch are determined.

When the first touch is maintained at 508, e.g., contact is sustained with the touch-sensitive display 118 when the second touch is detected, the process continues at 510. The second touch is selected 510 by disregarding signals from the first touch at the location 600. The coordinates of the second touch are determined 512 to be associated with the virtual button for the letter “O” on the virtual keyboard 212, and the letter “O” is rendered in the data entry field 214.

In the present example, 1 touch is detected on the touch-sensitive display 118 at the location 600 shown in FIG. 6. When a touch, or contact with the touch-sensitive display 118, is detected 502, the coordinates of the touch are determined. The coordinates of the touch are determined 504 to be associated with the virtual button for the letter “F” on the virtual keyboard 212 and the letter “F” is rendered in the data entry field 214. When a second touch, e.g., at a second location 700 in FIG. 7, is detected 506, the coordinates of the second touch are determined.

When the first touch is maintained at 508 when the second touch is detected, the process continues at 510. The second touch is selected 510 by disregarding signals from the first touch at the location 600. The coordinates of the second touch are determined to be associated 512 with the virtual button for the letter “O” on the virtual keyboard 212, and the letter “O” is rendered in the data entry field 214.

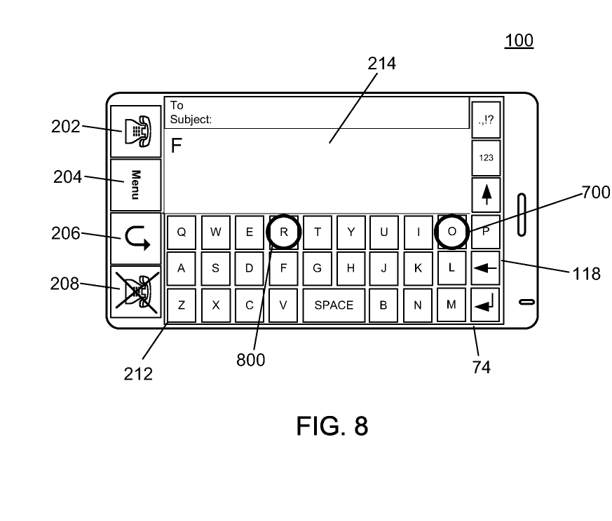

Continuing with the present example, a touch is detected on the touch-sensitive display 118 at a location 800 shown in FIG. 8. When a further touch is detected 506, the coordinates of the further touch are determined. When the prior touch is maintained when the further touch is detected, the process continues at 510. The further touch is selected 510 by disregarding signals from the second touch at the location 700. The coordinates of the further touch are determined 512 to be associated with the virtual button for the letter “R” on the virtual keyboard 212 and the letter “R” is rendered in the data entry field 214.

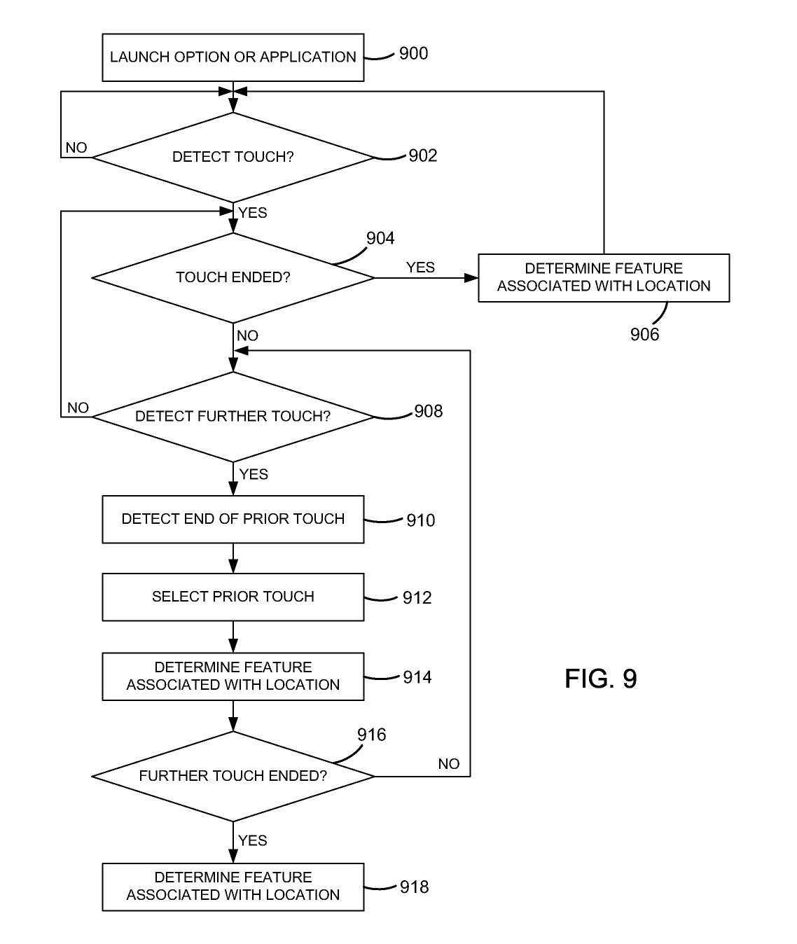

FIG. 9 is a flowchart illustrating another example of a method of controlling the portable electronic device 100 in accordance with FIG. 4. The processor 102 receives a selection of an application or an option within an application in which a graphical user interface is rendered and the selected option or application is launched 900. When a touch is detected 902, the coordinates of the touch are determined and the process continues at 904. If a touch is not detected, the process continues at 902. The portable electronic device 100 repeatedly or continually monitors for a touch on the touch-sensitive display 118. When the touch ends at 904, the coordinates of the first touch, as determined at 902 prior to the end of the first touch, are utilized to determine 906 which of a plurality of features is associated with the selected touch. When a further touch is not detected at 908, the process continues at 904. When a further touch is detected 908 that overlaps at least partially in time, the x and y co-ordinates of the further touch are determined. When the end of the prior touch is detected 910, the prior touch is selected 912 by disregarding signals from the touch-sensitive display 118 that are caused by the further touch and the coordinates of the prior touch, immediately prior to the end of the first touch, are utilized to determine 914 which of a plurality of features is associated with the selected touch. When the further touch has not ended at 916, the process continues at 908, where another touch may be detected. When the further touch ends at 916, the coordinates of the further touch, immediately prior to the end of the further touch on the touch-sensitive display 118, are utilized to determine 918 to determine 404 which of a plurality of features is associated with the selected touch.

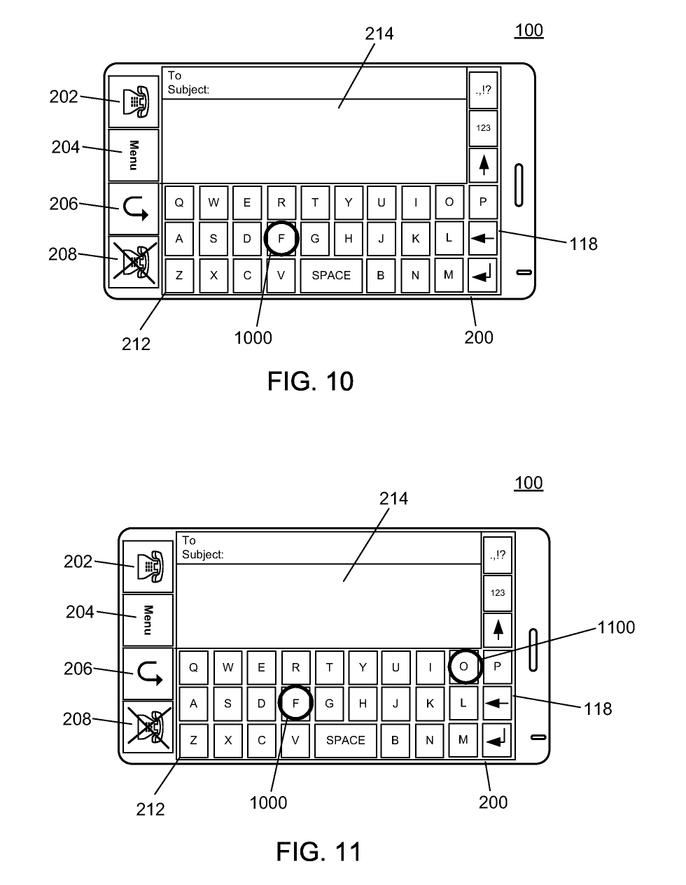

Continued reference is made to FIG. 9 with additional reference to FIG. 10 to FIG. 15 to describe a specific example of the method of controlling a portable electronic device 100. In the examples of FIG. 10 to FIG. 15, two thumbs may be utilized for touching the touch-sensitive display 118. The present disclosure is also applicable to other two-finger touching, two appendage touching, or multiple-touch conditions by any object suitable for detection by the touch-sensitive display 118.

According to the present example, the processor 102 receives a selection of an electronic mail composition option in an electronic mail application and an electronic mail composition application is launched 900. The virtual keyboard 212 is rendered in the electronic mail composition screen for entry of data in the form of characters such as alphanumeric characters and symbols in the fields 214, 216, 218.

In the present example, the touch is detected on the touch-sensitive display 118 at the location indicated by the numeral 1000 shown in FIG. 10. A first touch is detected 902. The touch location 1000 of the first touch is associated with the virtual button for the letter “F” on the virtual keyboard 212 on the touch-sensitive display 118. The letter “F” is not entered in the data entry field 214 when the first touch is detected.

The first touch has not yet ended at 904 when a second touch is detected 908 at the location indicated by the numeral 1100 shown in FIG. 11. The touch location 1100 of the second touch is associated with the virtual button for the letter “O” on the virtual keyboard 212 on the touch-sensitive display 118. The letter “O” is not entered in the data entry field 214 when the second touch begins. Further, the letter “F” is not entered when the second touch is detected.

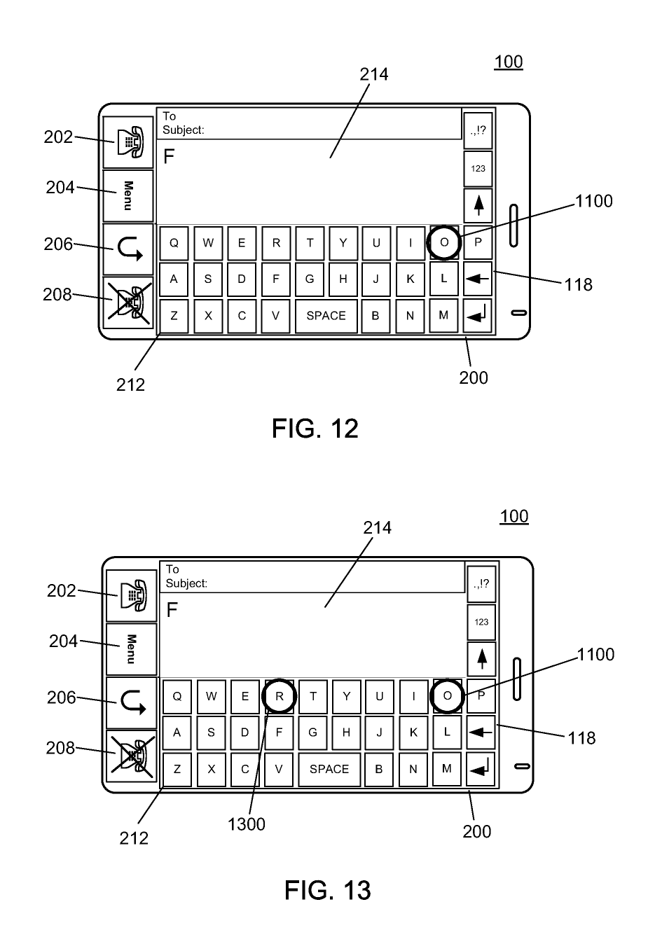

The first touch at the touch location 1000 ends at 910, the first touch is selected 912, and signals from the touch-sensitive display 118, which signals are caused by the second touch, are disregarded. The coordinates of the first touch are utilized to determine 914 the associated virtual button, the button for the letter “F”, and the letter “F” is rendered in the data entry field 214, as shown in FIG. 12.

For the purpose of the present example, the second touch has not ended at 916 when a further touch is detected 908. As shown in FIG. 13, the touch location 1300 of the second touch is associated with the virtual button for the letter “R” on the virtual keyboard 212. The letter “R” is not entered in the data entry field 214 when the further touch begins. Further, the letter “O” is not entered when the further touch is detected.

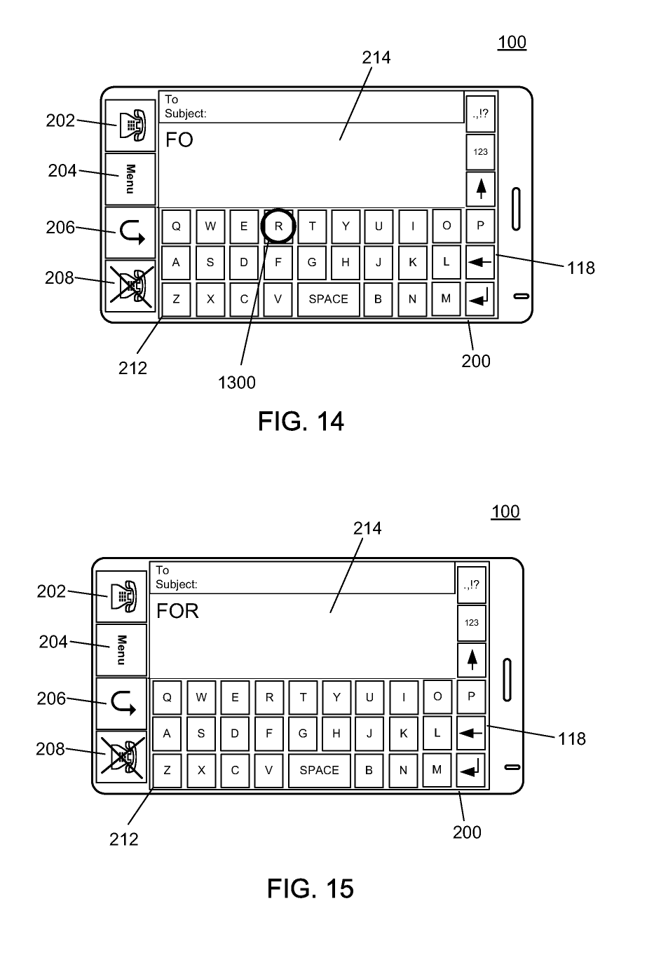

When the second touch at the touch location 1100 ends at 910, the second touch is selected 912 by disregarding signals, from the touch-sensitive display 118, that are caused by the further touch. The coordinates of the second touch, immediately prior to the end of the second touch, are utilized to determine 914 the associated virtual button, in this case the button for the letter “O”, and the letter “O” is rendered in the data entry field 214, as shown in FIG. 14.

In the present example, the further touch is ends at 916. The coordinates of the further touch, immediately prior to the end of the further touch, are utilized to determine 918 the associated virtual button, the button for the letter “R”, and the letter “R” is rendered in the data entry field 214, as shown in FIG. 15.

The present disclosure is not limited to the use of the virtual keyboards or keypads, as the use many other keyboards or keypads are possible. Further, many other features may be selected through touch than those described herein.

A method includes detecting a first touch on a touch-sensitive display, detecting a second touch on the touch-sensitive display while the first touch is maintained, selecting one of the first and second touches as a selected touch based on start or end times of the first and second touches, and determining which one of a plurality of features is associated with a location of the selected touch.

A portable electronic device includes a touch-sensitive display and at least one processor operably connected to the touch-sensitive display and configured to perform the above method.

A computer-readable medium has computer-readable code executable by at least one processor to perform the above method.

A method includes detecting a first touch on a touch-sensitive display, detecting a second touch on the touch-sensitive display while the first touch is maintained, and identifying one of the first and second touches to disregard based on start or end times of the first and second touches.

Advantageously, when more than one touch occurs at the portable electronic device at the same time, one of the touches is selected by filtering out signals from the touch-sensitive display resulting from the other of the touches. Signals from a single touch are therefore used to determine a location on the touch-sensitive display and determine an associated feature. When using thumbs for typing, there may be overlap of touches during which time both thumbs simultaneously touch the touch-sensitive display for selection of characters. By selecting one of the touches when two touches are detected, the touch location of each touch may be used to determine associated selectable features. Thus, each character may be entered. This may reduce device use time as each character may be entered, rather than missing characters when more than one touch occurs at one time. Fewer errors may therefore occur, reducing device use time and thereby decreasing power consumption and battery use.

Features on the touch-sensitive display such as characters may be entered when the end of the touch event is detected, which facilitates adjustment of the location of touch prior to entry to increase accuracy of selection. A second touch on the touch-sensitive display, as may occur, for example, when typing with two thumbs, prior to an end of a touch by the first finger on the touch-sensitive display, does not force entry of the character at the location of the first touch. The user may therefore make adjustments to increase accuracy of the selection even with a second finger on the screen.

While the embodiments described herein are directed to particular implementations of the portable electronic device and the method of controlling the portable electronic device, it will be understood that modifications and variations may occur to those skilled in the art. All such modifications and variations are believed to be within the sphere and scope of the present disclosure. The described embodiments are to be considered in all respects only as illustrative and not restrictive. The scope of the disclosure is, therefore, indicated by the appended claims rather than by the foregoing description. All changes that come within the meaning and range of equivalency of the claims are to be embraced within their scope.

What is claimed is:

1. A method comprising:
detecting a first touch on a touch-sensitive display;
detecting a second touch on the touch-sensitive display while the first touch is maintained;
selecting one of the first and second touches as a selected touch based on start or end times of the first and second touches; and
determining which one of a plurality of features is associated with a location of the selected touch.

2. The method according to claim 1, wherein selecting comprises selecting based on a later start time of the selected touch.

3. The method according to claim 1, wherein determining occurs prior to detecting the second touch.

4. The method according to claim 1, comprising, when the first touch is the selected touch, disregarding the second touch, and when the second touch is the selected touch, disregarding the first touch.

5. The method according to claim 4, wherein disregarding comprises disregarding signals from the disregarded touch.

6. The method according to claim 1, wherein detecting a first touch comprises determining touch coordinates of the first touch and detecting a second touch comprises determining touch coordinates of the second touch.

7. The method according to claim 1, comprising rendering a keyboard on the touch-sensitive display prior to detecting the first touch and wherein the plurality of selectable features comprises at least one of alphanumeric and symbolic characters from a keyboard.

8. The method according to claim 1, wherein the one of the plurality of features is a character from a keyboard.

9. The method according to claim 1, comprising detecting an end of the first touch prior to selecting.

10. The method according to claim 1, wherein determining occurs prior to the end of the first touch.

11. A portable electronic device comprising:
a touch-sensitive display; and
at least one processor operably connected to the touch-sensitive display, and configured to detect a first touch on the touch-sensitive display, detect a second touch on the touch-sensitive display while the first touch is maintained, select one of the first and second touches as a selected touch based on start or end times of the first and second touches, and determine which one of a plurality of features is associated with a location of the selected touch.

12. A computer-readable medium having computer-readable code executable by at least one processor of an electronic device comprising a touch-sensitive display to detect a first touch on the touch-sensitive display, detect a second touch on the touch-sensitive display while the first touch is maintained, select one of the first and second touches as a selected touch based on start or end times of the first and second touches, and determine which one of a plurality of features is associated with a location of the selected touch.

13. A method comprising:
detecting a first touch on a touch-sensitive display;
detecting a second touch on the touch-sensitive display while the first touch is maintained;
identifying one of the first and second touches to disregard based on start or end times of the first and second touches.

14. The method according to claim 13, wherein disregarding comprises disregarding based on a later start time of the disregarded touch.

15. The method according to claim 13, comprising, when the first touch is the disregarded touch, selecting the second touch, and when the second touch is the disregarded touch, selecting the first touch.

16. The method according to claim 15, comprising determining which one of a plurality of features is associated with a location of the selected touch.
